(19) United States
(12) Patent Application Publication
(10) Pub. No.: US 2019/0089743 A1
(43) Pub. Date: Mar. 21, 2019

(54) POLICIES BASED ON CLASSIFICATION OF GROUPS, TEAMS, AND SITES

(71) Applicant: MICROSOFT TECHNOLOGY LICENSING, LLC, Redmond, WA (US)

(72) Inventors: Dheepak RAMASWAMY, Bellevue, WA (US); Kavita K. KAMANI, Redmond, WA (US); Maithili Vijay DANDIGE, Kirkland (US); Mingquan XUE, Redmond, WA (US); Sanjoyan MUSTAFI, Suzhou (CN); Sheryl A. NOLAN, Snoqualmie, WA (US); Shilpa RANGANATHAN, Sammamish, WA (US)

(73) Assignee: MICROSOFT TECHNOLOGY LICENSING, LLC, Redmond, WA (US)

(21) Appl. No.: 15/710,808

(22) Filed: Sep. 20, 2017

(51) Int. Cl. H04L 29/06; G06Q 10/10

(52) U.S. Cl. CPC H04L 63/20; G06Q 30/018; G06Q 10/103

(57) ABSTRACT

Information technology use policies based on classification of groups, teams, and sites is provided. Example systems may enable information technology administrators to specify which policies may apply based on manual or automatic classification of groups, teams and sites. This may include the ability to specify associated membership, sharing, and access policies, data storage and sharing locations, retention policies for different types of content, and application of various information governance and protection options/requirements. Information technology administrators, who inherently understand the data and information management needs of organizations and members, may define a reasonable set of simplified classification options that information workers can use. Thus, information workers may no longer need to learn the details of data policies. They can simply select the proper data classification, and the security and compliance service may automatically configure the associated groups, teams, sites, and associated data.

### BACKGROUND

Information technology administrators need to stay in control of their corporate data to prevent data misuse and regulatory violations. Some of the challenges include increased speed of business and resulting generation and consumption of large amounts of data; increasing use of home offices, remote access, and personal devices; increased collaboration among workers, businesses, and other entities; increase of intellectual property theft; and increasing and broadening regulations on information governance and data retention, which may vary in different jurisdictions.

Information workers are required to handle organizational data in compliance with policies set by their organizations, industries, and/or regulators. They are responsible for preventing sensitive data from being accessed by unauthorized people and knowing what people should be authorized). User policy and technical education is typically challenging and may be expensive. Thus, information workers may rely on company policies that they may need to learn, understand, and apply, to stay in compliance.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to information technology use policies based on classification of groups, teams, and sites. One or more options may be provided to an administrator for selecting policies and restrictions associated with a label by a security and compliance service. The label may be published through the security and compliance service in response to an administrator selection and presented to an end user for association with a collaborative entity that may include a group, a team, or a site. Upon association of the label with the collaborative entity, policies and restrictions selected by the administrator for the label may be applied to the collaborative entity.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A through 1C include display diagrams illustrating an example network environment where a system to provide information technology use policies based on classification of groups, teams, and sites may be implemented;

FIG. 2 includes a display diagram illustrating an example flow of a system to provide information technology use policies based on classification of groups, teams, and sites;

FIG. 3 includes a display diagram illustrating an example user interface of a security and compliance service presenting example labels associated with policies;

FIG. 4 includes a display diagram illustrating another example user interface of a security and compliance service displaying polices associated with groups and sites based on selected labels;

FIG. 5 includes a display diagram illustrating a further user interface of a security and compliance service for actions associated with labels;

FIG. 6 includes a display diagram illustrating yet another user interface of a security and compliance service for bulk actions associated with labels;

FIG. 7 includes a display diagram illustrating a user interface of a security and compliance service for creating a group and associating applicable polices based on a label selection;

FIG. 8 is a networked environment, where a system according to embodiments may be implemented;

FIG. 9 is a block diagram of an example general purpose computing device, which may be used to provide information technology use policies based on classification of groups, teams, and sites; and

FIG. 10 illustrates a logic flow diagram of a method to provide information technology use policies based on classification of groups, teams, and sites,

all arranged in accordance with at least some embodiments described herein.

### DETAILED DESCRIPTION

As briefly described above, embodiments are directed to information technology use policies based on classification of groups, teams, and sites. A system according to embodiments may enable information technology administrators to specify which policies may apply based on manual or automatic classification of groups, teams and sites. This may include the ability to specify associated membership, sharing, and access policies, data storage and sharing locations, retention policies for different types of content, and application of various information governance and protection options/requirements.

Information technology administrators, who inherently understand the data and information management needs of organizations and members, may define a reasonable set of simplified classification options that information workers can use. Thus, information workers may no longer need to learn the details of data policies (e.g., which protection and information governance rules to apply and when). They can simply select the proper data classification, and the security and compliance service may automatically configure the associated groups, teams, sites, and associated data.

Example embodiments are described herein for applying policies to groups, teams, and sites. As used herein, teams refer to organizational entities that are formed for internal collaboration and may provide collective communication (e.g., chat), collaborative websites usage, shared workloads and services, etc. Groups are similar entities that may also allow external persons or entities to be included in a collaborative configuration, and allow custom landing pages on websites, news feeds, communication, data storage options, and other features. For example, groups may enable customization of email, calendar, notebook, and business intelligence applications for collaborative purposes. Teams may build on group features with enhanced features to allow users to utilize the features efficiently. Sites refers to intra-organization or external (e.g., Internet) websites or other online services that provide collaborative functionality to a group of users. Embodiments are not limited to application of the discussed policy configurations and utilization to these example collaborative entities, however, and may be implemented in any collaborative entity using the principles described herein.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing information technology use policies based on classification of groups, teams, and sites. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

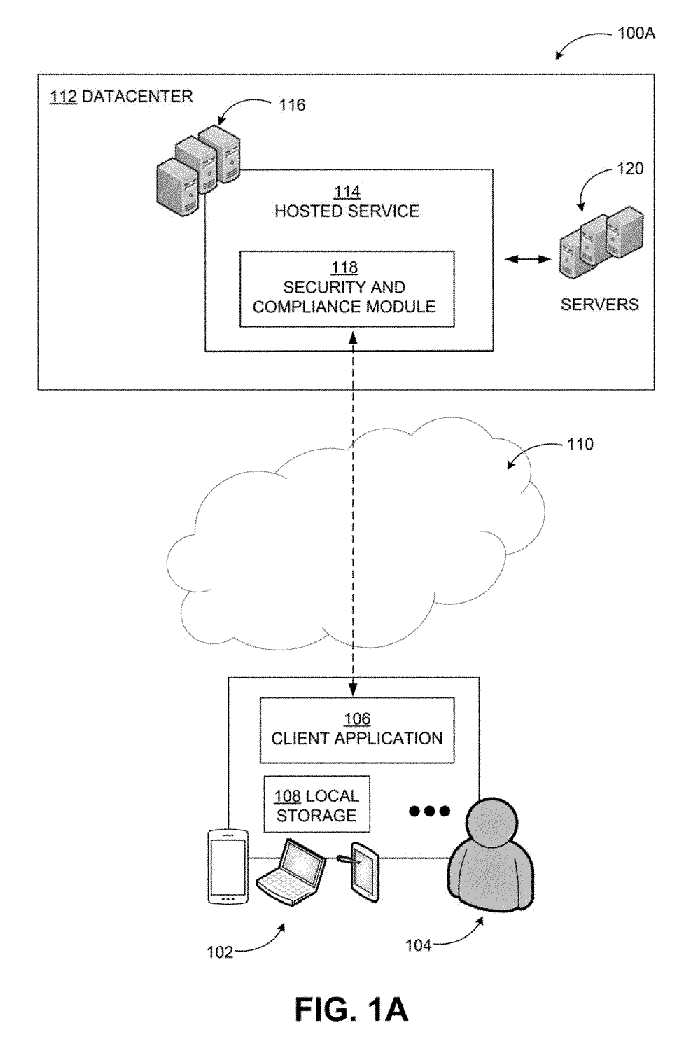

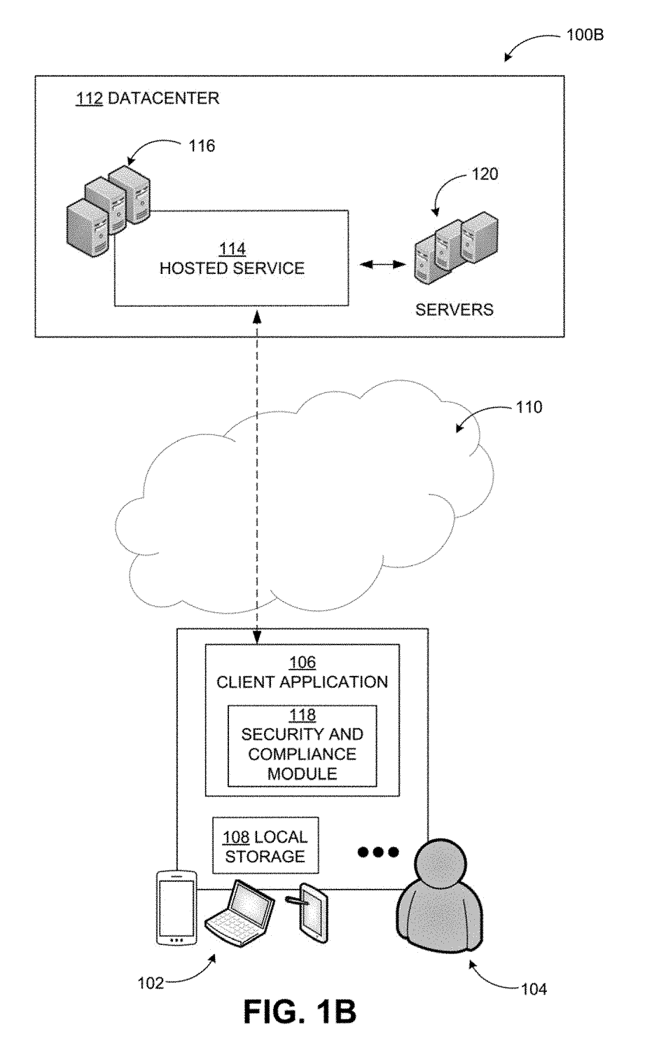

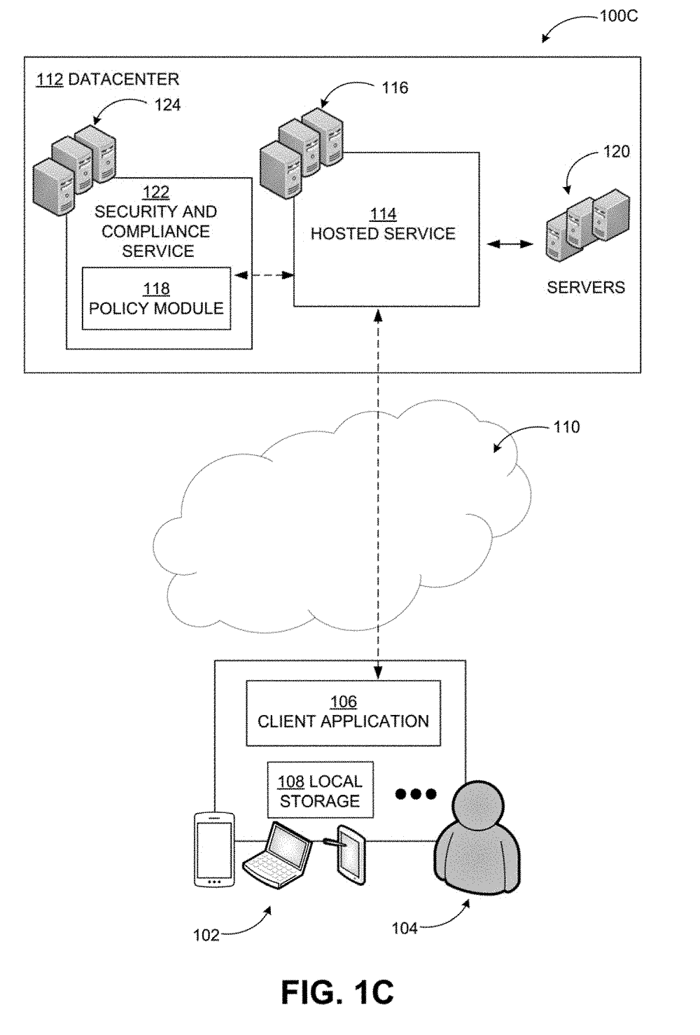

FIGS. 1A through 1C include display diagrams illustrating an example network environment where a system to provide information technology use policies based on classification of groups, teams, and sites may be implemented.

As illustrated in diagrams 100A-100C, an example system may include a datacenter 112 executing a hosted service 114 on at least one processing server 116, which may provide productivity, communication, cloud storage, collaboration, and comparable services to users in conjunction with other servers 120, for example. The hosted service 114 may further include scheduling services, online conferencing services, and comparable ones. The hosted service 114 may be configured to interoperate with a client application 106 through one or more client devices 102 over one or more networks, such as network 110. The client devices 102 may include a desktop computer, a laptop computer, a tablet computer, a vehicle-mount computer, a smart phone, or a wearable computing device, among other similar devices. In some examples, the hosted service 114 may allow users to access its services through the client application 106 executed on the client devices 102. In other examples, the hosted service 114 may be provided to a tenant (e.g., a business, an organization, or similar entities), which may configure and manage the services for their users.

In one embodiment, as illustrated in diagram 100A, the processing server 116 may be operable to execute a security and compliance module 118 of the hosted service 114, where the security and compliance module 118 may be integrated with the hosted service 114. In another embodiment, as illustrated in diagram 100B, the client application 106 may be operable to execute the security and compliance module 118, where the security and compliance module 118 may be integrated with the client application 106. In a further embodiment, as illustrated in diagram 100C, a policy module 128 may be integrated with a security and compliance service 122 and executed by one or more processing servers 124 of the security and compliance service 122. The security and compliance service 122 may be configured to serve the hosted service 114 and/or multiple applications associated with the hosted service 114, such as the client application 106. Furthermore, the security and compliance service 122 may provide its services to multiple hosted services. Thus, if a tenant subscribes to multiple hosted services, common information (e.g., policies, user profiles, data and metadata) may be used to coordinate suggested policies and configurations reducing duplication of policy implementation burden on the administrators. As described herein, the hosted service 114, the security and compliance service 122, and the policy module 128 may be implemented as software, hardware, or combinations thereof.

The security and compliance service 122 or the policy module 128 may be configured to enable information technology administrators to specify which policies may apply based on manual or automatic classification of groups, teams and sites. This may include the ability to specify associated membership, sharing, and access policies, data storage and sharing locations, retention policies for different types of content, and application of various information governance and protection options/requirements.

The security and compliance service 122 or the policy module 128 may also be configured to enable information technology administrators to edit and publish labels associating selected groups, teams, or sites, with one or more applicable policies. Subsequently, end users may be enable to associate their groups, teams, or sites, with one or more policies by selecting a label through a group/team/site definition user interface. The selected policies may be implemented automatically by the security and compliance service 122 or the policy module 128.

As previously discussed, challenges such as increased speed of business and resulting generation and consumption of large amounts of data; increasing use of home offices, remote access, and personal devices; increased collaboration among workers, businesses, and other entities; increase of intellectual property theft; and increasing and broadening regulations on information governance and data retention, which may vary in different jurisdictions, may degrade user experience and efficiency of enhanced collaboration tools. Implementation of information technology use policies based on classification of groups, teams, and sites as described herein may allow administrators to define policies for different groups, teams, and sites efficiently and users to associate their groups, teams, and sites easily with applicable policies without having to learn the details. By associating proper policies and configurations with groups, teams, sites automatically, processing and network capacity may be preserved, data security may be enhanced, usability may be improved, and user interactivity may be increased.

Embodiments, as described herein, address a need that arises from a very large scale of operations created by software-based services that cannot be managed by humans. The actions/operations described herein are not a mere use of a computer, but address results of a system that is a direct consequence of software used as a service offered in conjunction with a large number of devices and users using hosted services.

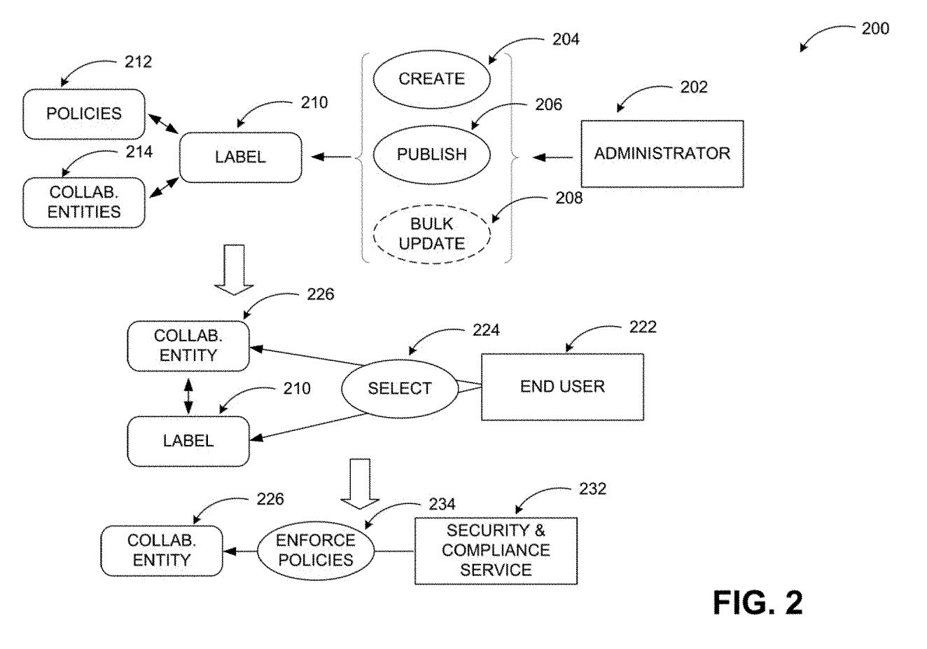

FIG. 2 includes a display diagram illustrating an example flow of a system to provide information technology use policies based on classification of groups, teams, and sites.

Diagram 200 shows conceptually an administrator 202 being enabled to create 204, publish 206, and perform bulk updates 208 to labels 210, which may define policies 212 for collaborative entities 214 such as groups, teams, and sites. Once the labels 210 are published, they may be made available to an end user 222 for selection 224. The end user 222 may be creating a new collaborative entity 226 or revising an existing one. The end user 22 may simply select 224 a label 210 for the collaborative entity 226 instead of having to understand and process a number of potentially applicable policies. Once the selected label is associated with the collaborative entity, a security and compliance service 232 or similar service may enforce the policies 234 identified in the label 210 for the collaborative entity 226.

Label 210 may identify security, compliance, and lifecycle policies for collaborative entities within specific containers. Containers refer to specific services, applications, or combinations thereof that provide a platform for the collaborative entities. Labels may be published to locations where end users create a collaborative entity. For example, all end users within a tenant of a service provider may have access to the labels. In other examples, specific boundaries (types of end users, etc.) may be defined to have access to subsets or all of the labels. Labels in a publishing policy may be available in end points (applications, services, modules, etc. that create a collaborative entity) through a policy synchronization mechanism, a REST API, or comparable mechanism. Once a label is applied to a collaborative entity, it may be stored in an appropriate container object. An applied label may also result in creation of a queue item for the security and compliance service or a component thereof. The service may subsequently detect the queue entry and write the settings defined in the label into one or more objects associated with applications, services, or modules providing various collaborative services to the created collaborative entity. Standard or proprietary application programming interfaces (APIs) or synchronization frameworks may be used to disseminate the information.

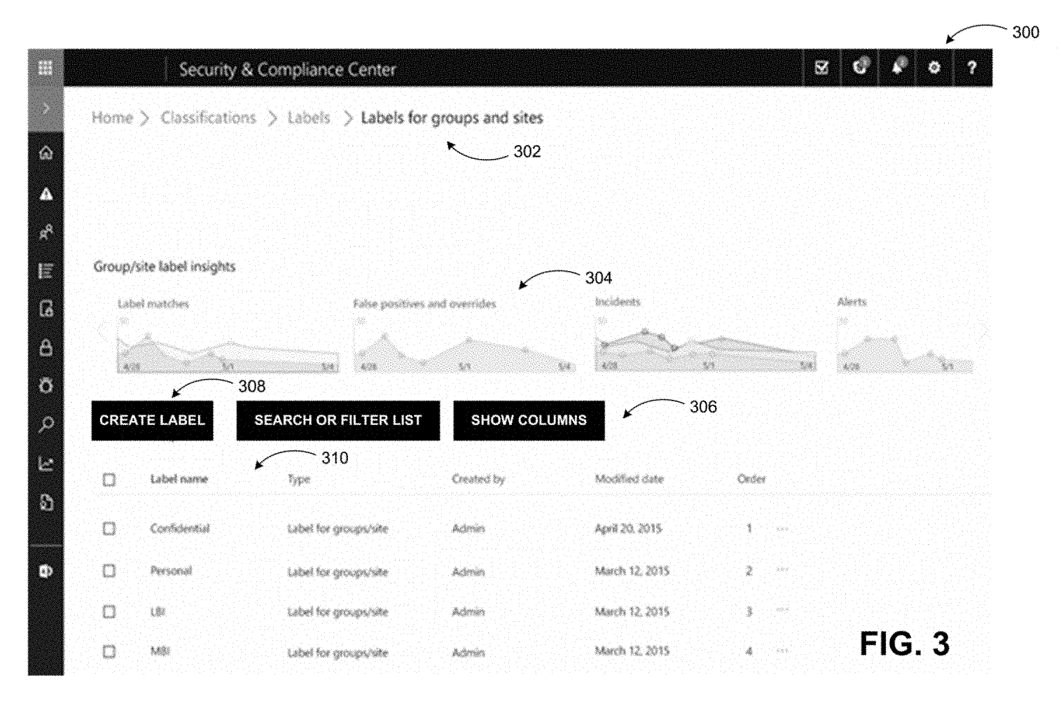

FIG. 3 includes a display diagram illustrating an example user interface of a security and compliance service presenting example labels associated with policies.

Diagram 300 shows a dashboard of a security and compliance service directed to labels for collaborative entities 302. In an example dashboard, textual or graphical information (insights 304) may be presented to provide a user (or an administrator) information associated with label matches, false positives (for policy violation), incidents, and alerts, for example. Other information may also be provided such as a listing of currently published labels 310. The listing may include label names, types, creators, created or modified dates, order of priority, etc. The dashboard may also include control elements 306 for actions associated with labels such as a control element for filtering or searching through the listing, a control element for selecting columns to be presented on the listing, or a control element 308 for creating a new label.

A security and compliance service may provide preconfigured labels in addition to allowing administrators to create new labels or edit existing ones. Creation of new labels may be simplified for administrators by letting them define a label name and a label description. Administrators may be allowed to specify a default classification for the label. Some classification labels may be allowed not to have any policy assigned. Specification of sort order may be allowed for classification labels. Administrators may be allowed to make selected labels inactive or deleted existing labels (e.g., if no collaborative entity is using them).

In some embodiments, policies may be classification-driven. Policies may be provided for membership of and access to the collaborative entities. For example, a group's privacy setting (e.g., public/private) may applies to all workloads for that group. Policies may also regulate external sharing. Different platforms' (e.g., communication service and collaboration service) settings may be tied together via a classification label. Policies may also control device access allowing or denying non-compliant or non-domain joined devices. Furthermore, policies may be directed to content settings. For example, blocked content labels may be created for collaborative entities. Conditions for auto labeling content may also be defined by policies identified in labels for the collaborative entities.

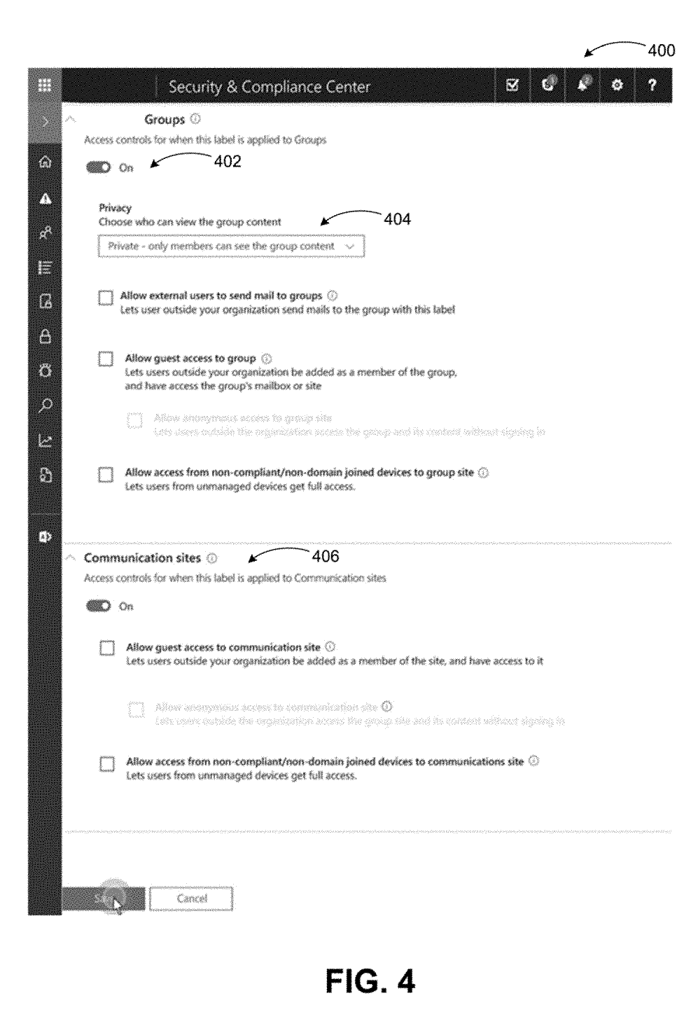

FIG. 4 includes a display diagram illustrating another example user interface of a security and compliance service displaying polices associated with groups and sites based on selected labels.

Diagram 400 shows a user interface that allows an administrator to select specific policies for a label. In some examples, a label may be applicable to more than one collaborative entity such as a group and a site. The example label in diagram 400 may identify a privacy policy 404 defining who can view content associated with the group, whether or not external users are allowed to send communication to the group, whether or not guest access to the group is allowed, and whether or not non-compliant or non-domain joined devices are allowed to access the group. A control element 402 may allow the administrator to turn on or off the group policies associated with the label. Similarly, policies directed to sites 406 associated with the label may include whether or not guest access is allowed to the site and whether or not non-compliant or non-domain joined devices are allowed to access the site.

The controls and policies displayed for an example label on diagram 400 are for illustration purposes only and do not constitute a limitation on embodiments. Additional or fewer policies, custom policies, and other behavior controls for the collaborative entities may be defined in the label.

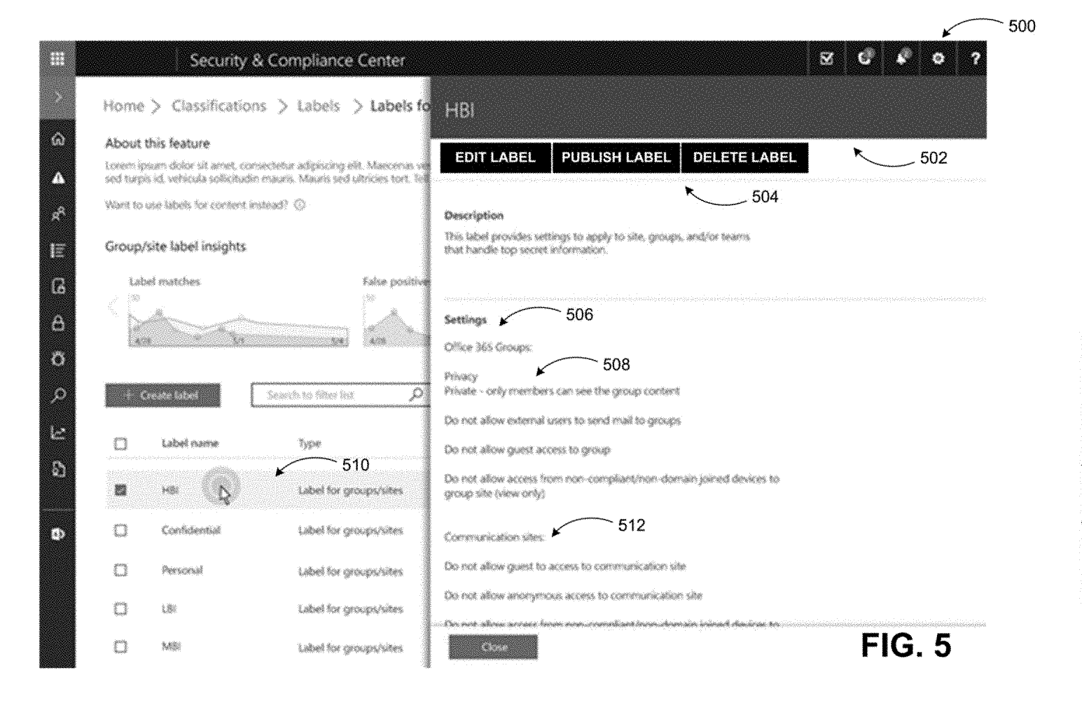

FIG. 5 includes a display diagram illustrating a further user interface of a security and compliance service for actions associated with labels.

The example user interface in diagram 500 allows an administrator to select 510 a label 502 from the listing of available labels within the security and compliance service and perform actions 504 such as editing the label 502, publishing the label 502 (for use by end users) or deleting the label 502.

Upon selection of the label 502, a description of the label may be displayed along with settings 506 associated with the label such as policies associated with groups 508 and policies associated with sites 512 under the label 502. The user interface in diagram 500 may follow the user interface in diagram 300 of FIG. 3 upon selection of one of the labels in the listing of labels discussed above.

In an example process, an administrator may select a migration path for collaborative entity policies and develop an associated change management plan. Next, the administrator may send the change management notification to end users explaining the roll-out of new labels and associated policies, calling out required actions and implications. The administrator may create and publish new labels and policies via the security and compliance service. Once the labels are published, new groups, teams, and sites may be created using the security and compliance service's labels and policies.

For existing collaborative entities, an administrator may execute two processes (e.g., using a script), the first one updating old labels to new labels (if the old labels did not define specific policies, the resulting labels may also have no policy association unless manually modified). The second process may enforce label policies on the new labels (e.g. a general group that had privacy classification set to Public may be updated to Private).

In some examples, administrators may need to handle changes to some groups manually. For example, a “Highly Confidential” group may need to block external guest access. If guests existed in the group prior to migration, the administrator may need to decide how to handle and update accordingly (e.g., the guests may need to be expired or removed). For workloads that have not yet moved to a security and compliance service endpoint, the administrator may choose to: modify the list of classification labels to match the newly created list (if different), delete the list of old classification labels such that only the new classification labels are assigned to containers, periodically execute scripts for the above discussed two processes to continually migrate affected groups to use the new classification labels, and/or put in place a policy such that new groups created with old labels fail.

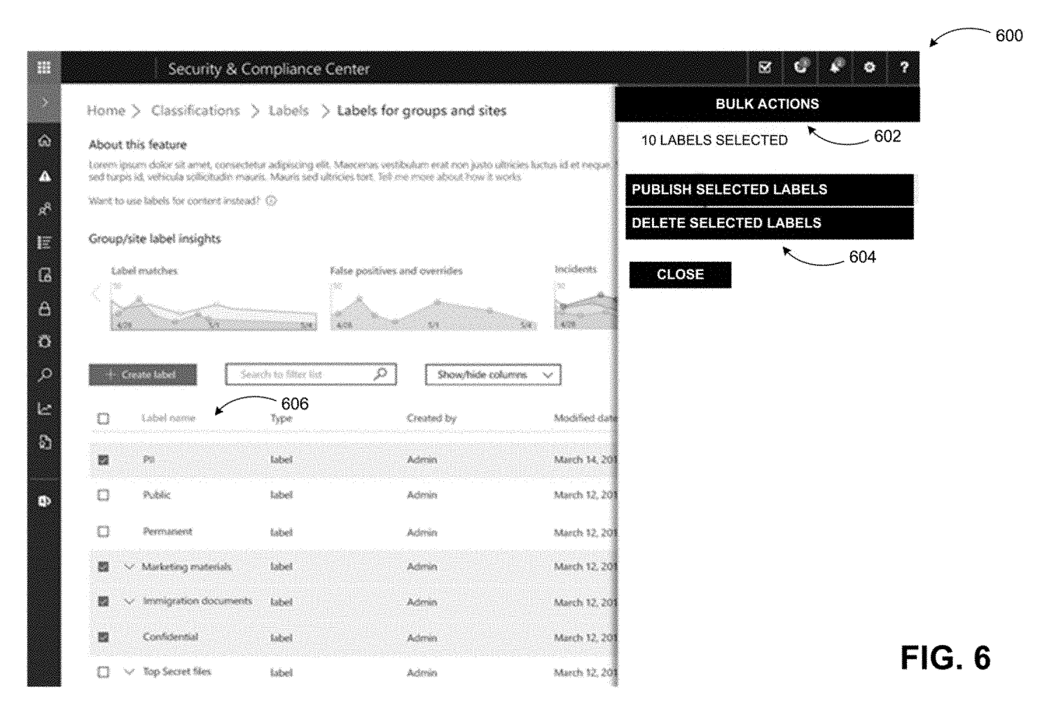

FIG. 6 includes a display diagram illustrating yet another user interface of a security and compliance service for bulk actions associated with labels.

Diagram 600 shows an example user interface illustrating bulk actions on labels. Upon selection of multiple labels 606 in the user interface of diagram 300 of FIG. 3, a “Bulk Actions” view 602 may be presented. The “Bulk Actions” view 602 may display a number of labels selected and provide control elements 604 that allows an administrator to publish or deleted the selected multiple labels. Once published, the selected labels may be used by end users to associate their respective collaborative entities with one or more policies through the published labels. Some examples of labels may include “Highly Confidential”, “Business Confidential”, “Private”, “Public”, and comparable ones.

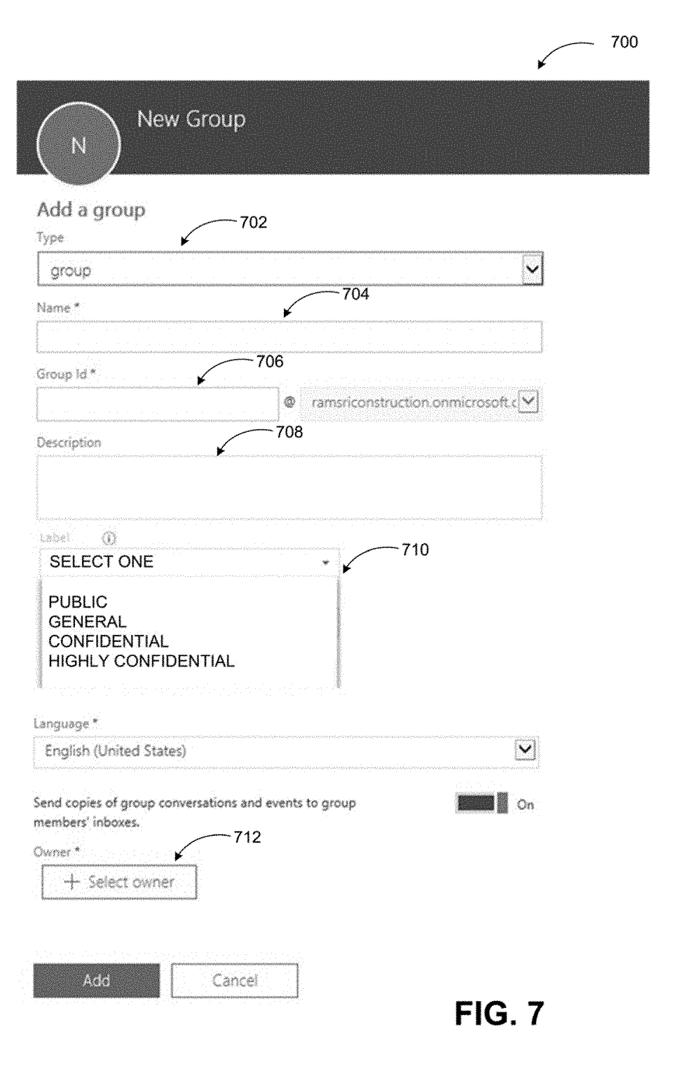

FIG. 7 includes a display diagram illustrating a user interface of a security and compliance service for creating a group and associating applicable polices based on a label selection.

As discussed herein, end users may simply select the proper classification for their collaborative entities and the security and compliance service may automatically configure the associated groups, teams, sites, and associated data without a need for the end users to learn the details of data policies. The example user interface in diagram 700 shows how an end user can create a collaborative entity (in this case a group) and associate applicable policies through a label. Example definitions and selections on the user interface may include a type 702 of the collaborative entity, a name 704 of the group, an identifier 706 (e.g., an alphanumeric string) of the group that may also be used as communication alias for the group, and a description 708 of the group.

An end user may further be allowed to select a label 710 for the group. The name of the group may summarize policies associated with the label (e.g., “Highly Confidential” may have the most restrictive policies, while “Public” may have the most relaxed policies). Additionally, a default language for the group and an owner 712 (manager) of the group may also be identified through the user interface. Further controls and definitions may also be enabled through the user interface depending on the type of the collaborative entity.

The example user interfaces discussed above not limited to the above described components and features. Various graphical, textual, coloring, shading, and visual effect schemes may be employed to present policy and label configuration and selection options according to embodiments.

The examples provided in FIGS. 1A through 7 are illustrated with specific systems, services, applications, modules, and displays. Embodiments are not limited to environments according to these examples. Information technology use policies based on classification of groups, teams, and sites may be implemented in environments employing fewer or additional systems, services, applications, modules, and displays. Furthermore, the example systems, services, applications, modules, and notifications shown in FIG. 1A through 7 may be implemented in a similar manner with other user interface or action flow sequences using the principles described herein.

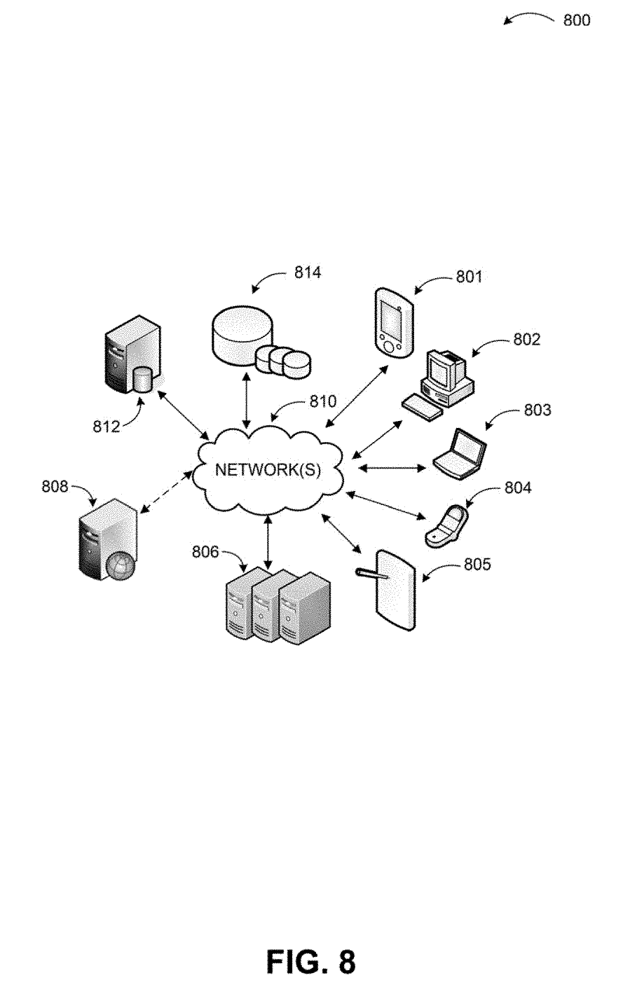

FIG. 8 is a networked environment, where a system according to embodiments may be implemented.

A security and compliance service (or module) as described herein may be employed in conjunction with hosted applications and services (for example, the client application 106 associated with the hosted service 114 or the security and compliance service 122) that may be implemented via software executed over one or more servers 806 or individual server 808, as illustrated in diagram 800. A hosted service or application may communicate with client applications on individual computing devices such as a handheld computer 801, a desktop computer 802, a laptop computer 803, a smart phone 804, a tablet computer (or slate), 805 (‘client devices’) through network(s) 810 and control a user interface, such as a dashboard, presented to users.

Client devices 801-805 are used to access the functionality provided by the hosted service or client application. One or more of the servers 806 or server 808 may be used to provide a variety of services as discussed above. Relevant data may be stored in one or more data stores (e.g. data store 814), which may be managed by any one of the servers 806 or by database server 812.

Network(s) 810 may comprise any topology of servers, clients, Internet service providers, and communication media. A system according to embodiments may have a static or dynamic topology. Network(s) 810 may include a secure network such as an enterprise network, an unsecure network such as a wireless open network, or the Internet. Network(s) 810 may also coordinate communication over other networks such as PSTN or cellular networks. Network(s) 810 provides communication between the nodes described herein. By way of example, and not limitation, network(s) 810 may include wireless media such as acoustic, RF, infrared and other wireless media.

Many other configurations of computing devices, applications, engines, data sources, and data distribution systems may be employed to provide information technology use policies based on classification of groups, teams, and sites. Furthermore, the networked environments discussed in FIG. 8 are for illustration purposes only. Embodiments are not limited to the example applications, engines, or processes.

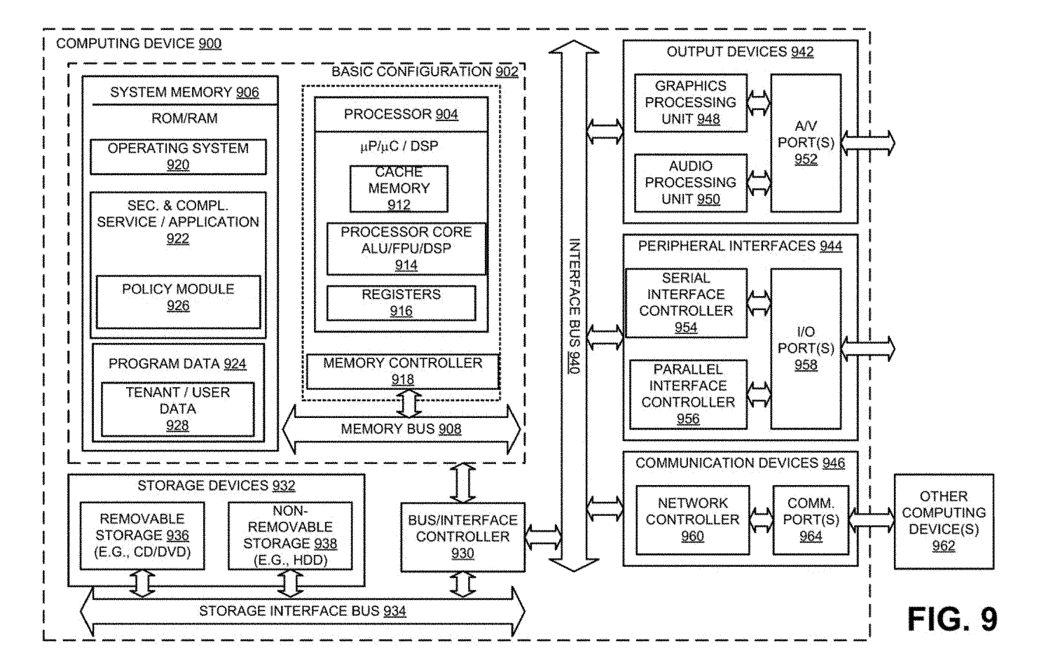

FIG. 9 is a block diagram of an example computing device, which may be used to provide information technology use policies based on classification of groups, teams, and sites.

For example, computing device 900 may be used as a server, desktop computer, portable computer, smart phone, special purpose computer, or similar device. In an example basic configuration 902, the computing device 900 may include one or more processors 904 and a system memory 906. A memory bus 908 may be used for communicating between the processor 904 and the system memory 906. The basic configuration 902 is illustrated in FIG. 9 by those components within the inner dashed line.

Depending on the desired configuration, the processor 904 may be of any type, including but not limited to a microprocessor (μP), a microcontroller (μC), a digital signal processor (DSP), or any combination thereof. The processor 904 may include one more levels of caching, such as a level cache memory 912, one or more processor cores 914, and registers 916. The example processor cores 914 may (each) include an arithmetic logic unit (ALU), a floating point unit (FPU), a digital signal processing core (DSP Core), or any combination thereof. An example memory controller 918 may also be used with the processor 904, or in some implementations the memory controller 918 may be an internal part of the processor 904.

Depending on the desired configuration, the system memory 906 may be of any type including but not limited to volatile memory (such as RAM), non-volatile memory (such as ROM, flash memory, etc.) or any combination thereof. The system memory 906 may include an operating system 920, a security and compliance application or service 922, and program data 924. The security and compliance application or service 922 may include a policy module 926, which may be an integrated module of the security and compliance application or service 922. The policy module 926 may be configured to enable administrators to define one or more policies associated with a label and publish the label such as end users can associated a new or existing group, team, or site with one or more applicable policies by simply selecting the published label. The program data 924 may include, among other data, tenant/user data 928, such as the user information, hosted service information, etc., as described herein.

The computing device 900 may have additional features or functionality, and additional interfaces to facilitate communications between the basic configuration 902 and any desired devices and interfaces. For example, a bus/interface controller 930 may be used to facilitate communications between the basic configuration 902 and one or more data storage devices 932 via a storage interface bus 934. The data storage devices 932 may be one or more removable storage devices 936, one or more non-removable storage devices 938, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 906, the removable storage devices 936 and the non-removable storage devices 938 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 900. Any such computer storage media may be part of the computing device 900.

The computing device 900 may also include an interface bus 940 for facilitating communication from various interface devices (for example, one or more output devices 942, one or more peripheral interfaces 944, and one or more communication devices 946) to the basic configuration 902 via the bus/interface controller 930. Some of the example output devices 942 include a graphics processing unit 948 and an audio processing unit 950, which may be configured to communicate to various external devices such as a display or speakers via one or more A/V ports 952. One or more example peripheral interfaces 944 may include a serial interface controller 954 or a parallel interface controller 956, which may be configured to communicate with external devices such as input devices (for example, keyboard, mouse, pen, voice input device, touch input device, etc.) or other peripheral devices (for example, printer, scanner, etc.) via one or more I/O ports 958. An example communication device 946 includes a network controller 960, which may be arranged to facilitate communications with one or more other computing devices 962 over a network communication link via one or more communication ports 964. The one or more other computing devices 962 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 900 may be implemented as a part of a general purpose or specialized server, mainframe, or similar computer that includes any of the above functions. The computing device 900 may also be implemented as a personal computer including both laptop computer and non-laptop computer configurations.

Example embodiments may also include methods to provide information technology use policies based on classification of groups, teams, and sites. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

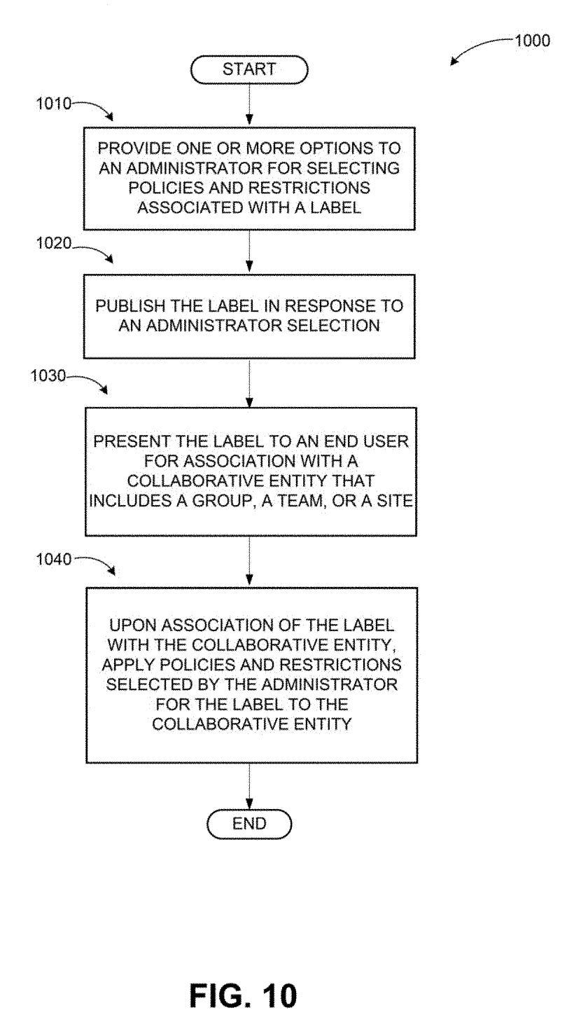

FIG. 10 illustrates a logic flow diagram of a method to provide information technology use policies based on classification of groups, teams, and sites. Process 1000 may be implemented on a computing device, server, or other system. An example server may comprise a communication interface to facilitate communication between one or more client devices and the server. The example server may also comprise a memory to store instructions, and one or more processors coupled to the memory. The processors, in conjunction with the instructions stored on the memory, may be configured to provide information technology use policies based on classification of groups, teams, and sites.

Process 1000 begins with operation 1010, where a security and compliance service may present an administrator with options to create (or edit) a label by defining label attributes such as name and description, as well as, selecting one or more policies and restrictions associated with the label. At operation 1020, the label may be published (made available to end users of the service) in response to a selection by the administrator.

At operation 1030, the published label may be presented to end users for association with a collaborative entity (e.g., group, team, or site) during creation or editing of the collaborative entity. The end users may be enabled to make the association through selection of the label and not need to know or select individual policies and restrictions. At operation 1040, the policies and restrictions defined in the label selected by the end user for their collaborative entity may be applied to the collaborative entity by the security and compliance service.

The operations included in process 1000 are for illustration purposes. Information technology use policies based on classification of groups, teams, and sites may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing policies based on classification of groups, teams, and sites is described. The means may include a means for providing one or more options to an administrator for selecting policies and restrictions associated with a label; a means for publishing the label in response to an administrator selection; a means for presenting the label to an end user for association with a collaborative entity comprising a group, a team, or a site; and upon association of the label with the collaborative entity, a means for applying policies and restrictions selected by the administrator for the label to the collaborative entity.

According to some examples, a method to provide policies based on classification of groups, teams, and sites is described. The method may include providing one or more options to an administrator for selecting policies and restrictions associated with a label; publishing the label in response to an administrator selection; presenting the label to an end user for association with a collaborative entity comprising a group, a team, or a site; and upon association of the label with the collaborative entity, applying policies and restrictions selected by the administrator for the label to the collaborative entity.

According to other examples, the method may further include providing the policies and restrictions for one or more of a membership of the collaborative entity, an access to the collaborative entity, a control of access to the collaborative entity through a non-compliant or a non-domain joined device, or a control of content associated with the collaborative entity. The control of content associated with the collaborative entity may include control of: a blocking of content, a sharing of content, a storage location for content, or a retention of content. The method may also include applying a policy defined by the label to all workloads associated with the collaborative entity.

According to further examples, the policies and restrictions may be classification driven. The method may also include associating the policies and restrictions for two or more platforms through a classification label. The two or more platforms may include individual hosted services or components of a hosted service. The method may further include allowing one or more conditions for auto labeling content associated with the collaborative entity to be defined by the one or more policies and restrictions identified by the label; providing, by a security and compliance service, one or more preconfigured labels; allowing the administrator to one or more of edit, inactivate, or delete and existing label; allowing the administrator to specify a default classification for the label; and/or allowing the administrator to create a classification label that lacks a definition of a policy.

According to other examples, a server configured to provide policies based on classification of groups, teams, and sites is described. The server may include a communication interface configured to facilitate communication between another server executing a hosted service, one or more client devices, and the server; a memory configured to store instructions; and one or more processors coupled to the communication interface and the memory and configured to execute a security and compliance service. The security and compliance service may be configured to provide a user interface to be presented to an administrator displaying one or more options for selecting one or more policies associated with a newly created or edited label; publish the label to one or more endpoints of the hosted service in response to an administrator selection; provide the label to be presented to an end user for association with a newly created or edited collaborative entity comprising a group, a team, or a site; and upon association of the label with the collaborative entity, apply the one or more policies selected by the administrator for the label to the collaborative entity, where the one or more policies define controls on one or more of a membership of the collaborative entity, an access to the collaborative entity, an access to the collaborative entity through a non-compliant or a non-domain joined device, or content associated with the collaborative entity.

According to some examples, the one or more endpoints may include components of the hosted service. The security and compliance service may be further configured to for existing collaborative entities, allow the administrator to update existing labels with new labels and enforce label policies on the new labels. The security and compliance service may also be configured to allow the administrator, through the user interface, to select a plurality of labels and bulk publish or bulk delete the selected plurality of labels. The security and compliance service may be further configured to for workloads that have not yet moved to a security and compliance service endpoint, allow the administrator to modify a list of classification labels to match a newly created list of classification labels, delete the list of classification labels such that only the new classification labels are assigned to collaborative entity platforms, and periodically execute a script to continually migrate affected groups to use the new classification labels.

According to further examples, a system configured to provide policies based on classification of groups, teams, and sites is described. The system may include a first server configured to execute one or more hosted services for a tenant and one or more users, and a second server. The second server may include a communication interface configured to facilitate communication between the first server and the second server; a memory configured to store instructions; and one or more processors coupled to the communication interface and the memory and configured to execute a security and compliance service. The security and compliance service may be configured to provide a user interface to be presented to an administrator to allow the administrator to create a label by selecting one or more policies to control behavior of a collaborative entity comprising a group, a team, or a site; publish the label to the one or more hosted services and components of the one or more hosted services that provide platforms for the collaborative entity as containers in response to an administrator selection; provide the label to be presented to an end user for association with the collaborative entity during a creation or edit process; and upon association of the label with the collaborative entity, store the label in a container associated with the collaborative entity and enforce the one or more policies selected by the administrator for the label on the collaborative entity.

According to yet other examples, the security and compliance service may be further configured to publish the label to containers for an entire tenant or a subset of the containers for the tenant. The security and compliance service may also be configured to create an entry in a hosted service policy queue such that a security and compliance service background process writes settings defined by the label to one or more objects of the hosted service through an application programming interface (API) or a policy synchronization framework.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide policies based on classification of groups, teams, and sites, the method comprising:
providing one or more options to an administrator for selecting policies and restrictions associated with a label;
publishing the label in response to an administrator selection;
presenting the label to an end user for association with a collaborative entity comprising a group, a team, or a site; and
upon association of the label with the collaborative entity, applying policies and restrictions selected by the administrator for the label to the collaborative entity.

2. The method of claim 1, further comprising:
providing the policies and restrictions for one or more of a membership of the collaborative entity, an access to the collaborative entity, a control of access to the collaborative entity through a non-compliant or a non-domain joined device, or a control of content associated with the collaborative entity.

3. The method of claim 2, wherein the control of content associated with the collaborative entity comprises control of:
a blocking of content, a sharing of content, a storage location for content, or a retention of content.

4. The method of claim 1, further comprising:
applying a policy defined by the label to all workloads associated with the collaborative entity.

5. The method of claim 1, wherein the policies and restrictions are classification driven.

6. The method of claim 1, further comprising:
associating the policies and restrictions for two or more platforms through a classification label.

7. The method of claim 6, wherein the two or more platforms include individual hosted services or components of a hosted service.

8. The method of claim 1, further comprising:
allowing one or more conditions for auto labeling content associated with the collaborative entity to be defined by the one or more policies and restrictions identified by the label.

9. The method of claim 1, further comprising:
providing, by a security and compliance service, one or more preconfigured labels.

10. The method of claim 1, further comprising:
allowing the administrator to one or more of edit, inactivate, or delete and existing label.

11. The method of claim 1, further comprising:
allowing the administrator to specify a default classification for the label.

12. The method of claim 1, further comprising:
allowing the administrator to create a classification label that lacks a definition of a policy.

13. A server configured to provide policies based on classification of groups, teams, and sites, the server comprising:
a communication interface configured to facilitate communication between another server executing a hosted service, one or more client devices, and the server;
a memory configured to store instructions; and
one or more processors coupled to the communication interface and the memory and configured to execute a security and compliance service, wherein the security and compliance service is configured to:
provide a user interface to be presented to an administrator displaying one or more options for selecting one or more policies associated with a newly created or edited label;
publish the label to one or more endpoints of the hosted service in response to an administrator selection;
provide the label to be presented to an end user for association with a newly created or edited collaborative entity comprising a group, a team, or a site; and
upon association of the label with the collaborative entity, apply the one or more policies selected by the administrator for the label to the collaborative entity, wherein the one or more policies define controls on one or more of a membership of the collaborative entity, an access to the collaborative entity, an access to the collaborative entity through a non-compliant or a non-domain joined device, or content associated with the collaborative entity.

14. The server of claim 13, wherein the one or more endpoints include components of the hosted service.

15. The server of claim 13, wherein the security and compliance service is further configured to:
for existing collaborative entities, allow the administrator to update existing labels with new labels and enforce label policies on the new labels.

16. The server of claim 13, wherein the security and compliance service is further configured to:
allow the administrator, through the user interface, to select a plurality of labels and bulk publish or bulk delete the selected plurality of labels.

17. The server of claim 13, wherein the security and compliance service is further configured to:
for workloads that have not yet moved to a security and compliance service endpoint, allow the administrator to modify a list of classification labels to match a newly created list of classification labels, delete the list of classification labels such that only the new classification labels are assigned to collaborative entity platforms, and periodically execute a script to continually migrate affected groups to use the new classification labels.

18. A system configured to provide policies based on classification of groups, teams, and sites, the system comprising:
a first server configured to execute one or more hosted services for a tenant and one or more users; and
a second server, comprising:
a communication interface configured to facilitate communication between the first server and the second server,
a memory configured to store instructions; and
one or more processors coupled to the communication interface and the memory and configured to execute a security and compliance service, wherein the security and compliance service is configured to:
provide a user interface to be presented to an administrator to allow the administrator to create a label by selecting one or more policies to control behavior of a collaborative entity comprising a group, a team, or a site;
publish the label to the one or more hosted services and components of the one or more hosted services that provide platforms for the collaborative entity as containers in response to an administrator selection;
provide the label to be presented to an end user for association with the collaborative entity during a creation or edit process; and
upon association of the label with the collaborative entity, store the label in a container associated with the collaborative entity and enforce the one or more policies selected by the administrator for the label on the collaborative entity.

19. The system of claim 18, wherein the security and compliance service is further configured to publish the label to containers for an entire tenant or a subset of the containers for the tenant.

20. The system of claim 18, wherein the security and compliance service is further configured to:
create an entry in a hosted service policy queue such that a security and compliance service background process writes settings defined by the label to one or more objects of the hosted service through an application programming interface (API) or a policy synchronization framework.
